(19) United States
(12) Patent Application Publication
(10) Pub. No.: US 2015/0201057 A1
(43) Pub. Date: Jul. 16, 2015

(54) METHOD OF PROCESSING TELEPHONE VOICE OUTPUT AND EARPHONE

(71) Applicant: Kuo-Ping YANG, Taipei (TW)

(72) Inventors: Kuan-Li CHAO, Taipei (TW); Neo Bob Chih-Yung YOUNG, Taipei (TW); Vincent Shuang-Pung LIAW, Taipei (TW); Kuo-Ping YANG, Taipei (TW)

(73) Assignee: Kuo-Ping YANG, Taipei (TW)

(21) Appl. No.: 14/271,621

(22) Filed: May 7, 2014

(30) Foreign Application Priority Data
Jan. 16, 2014 (TW) 103101544

(51) Int. Cl. H04M 1/60

(52) U.S. Cl. CPC H04M 1/6058

(57) ABSTRACT

A method of processing telephone voice output is used in an earphone. This method includes obtaining a corresponding adjustment parameter according to the phone identification information of the hearing-impaired so as to make the processing module in the earphone process the voice according to the adjustment parameter in advance and enable the hearing-impaired to hear more clearly.

### BACKGROUND OF THE INVENTION

1. Field of the Invention

The present invention relates to a method for enabling hearing-impaired people to identify accurately the voice of the other side more clearly when they are answering the phone, wherein it comprises an earphone using the above method.

2. Description of the Related Art

Hearing-impaired listeners who can hear sounds with the help of hearing aid devices often have difficulty hearing high-frequency sounds. Listeners with slight hearing impairment cannot hear sounds above 6,000 Hz, and those with severe hearing impairment cannot hear sounds above 2,000 Hz. For example, listeners with severe hearing impairment cannot hear sounds above 4,000 Hz even when the sounds are amplified to several times their original volume. Since consonant sounds are often above 4,000 Hz, the basic approach of hearing aid devices is to lower the frequency of the sound and to amplify it. In addition, hearing-impaired listeners can set some adjustment parameters according to their needs. The adjustment parameters are usually related to the frequency and the amplification of sounds to facilitate the processing of the sounds by the sound-processing program (software or firmware) inside the hearing aid devices.

When a hearing-impaired listener speaks with other people face to face, common hearing aid devices are sufficient, since the devices lower or remove high-frequency sounds so that the hearing-impaired listener can hear the original high-frequency sounds. However, when the hearing-impaired listener speaks to others on a telephone, problems may arise because the phone first removes the high-frequency sounds before transmission. For example, the traditional telephone first removes frequencies above 4,000 Hz before transmission. Therefore, no sounds above 4,000 Hz are sent through telephones, and hearing-impaired listeners cannot easily identify the correct sounds on telephones as long as one side uses a traditional landline (or even 2G and 3G phones), particularly in the case of single-syllable words comprising high-frequency consonants and short vowel sounds (such as “sit”) and words in monosyllabic languages (only one vowel) such as Chinese.

When the hearing-impaired listener communicates with others on a network telephone, a problem is that some Internet phones remove frequencies above 4,000 Hz.

Thus hearing-impaired listeners are in need of help in this regard.

### SUMMARY OF THE INVENTION

The primary object of the present invention is to provide a method to help hearing-impaired listeners identify sounds more clearly when speaking on the phone.

Another object of the present invention is to provide an earphone to achieve the above method.

To achieve the above-mentioned objects, the earphone used by the caller is electrically connected to a near-end phone with a cable or wirelessly, wherein the earphone comprises a microphone module, a sound processing module, a communication module, and a speaker module. The earphone receives the input voice of the caller via the microphone module and the adjustment parameter corresponding to the receiver at the same time. The sound processing module processes the input voice and generates the output voice signal, which a hearing-impaired listener can hear. Then the communication module transmits the output voice signal to the near-end phone and eventually to the far-end phone used by the hearing-impaired listener.

For example, when the caller calls the far-end phone of the hearing-impaired listener via the near-end phone, he/she may receive an adjustment parameter corresponding to the receiver and make the sound processing module in the earphone process the voice of the caller according to the adjustment parameter. The voice of the caller is processed in advance (such as the sounds are processed to below 4000 Hz) and transmitted to the electrical device that is able to make a call to the hearing-impaired listener. Therefore, the voice of the caller includes the sounds that originally were above 4000 Hz, and the hearing-impaired listener can hear the sounds.

According to this embodiment, the present invention is used on the far-end phone used by a hearing-impaired listener. The adjustment parameter may be downloaded through the network from the adjustment parameter service. Otherwise, the adjustment parameter database stored in an electrical device that is able to make a call or in the earphone in advance can be used as well. The adjustment parameter database may be either in the memory or not in the memory.

### BRIEF DESCRIPTION OF THE DRAWINGS

FIG. 1 is a schematic diagram of the use environment of the present invention.

FIG. 2 is a hardware structure drawing of the earphone of the present invention.

FIG. 3 is a flowchart of the present invention.

FIG. 4 is a schematic diagram of the present invention illustrating the adjustment parameter database.

FIG. 5 is a schematic diagram of the present invention illustrating how the sound processing module processes the input voice.

### DETAILED DESCRIPTION OF THE PREFERRED EMBODIMENT

To clarify the above and other purposes, features, and advantages of this invention, a specific embodiment of this invention is especially listed and described in detail with the attached figures as follows.

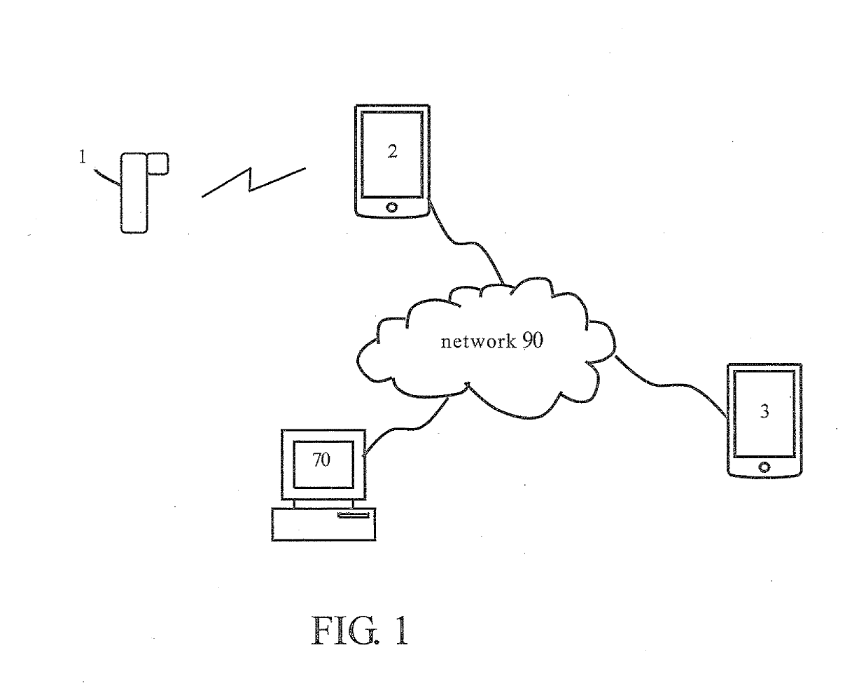

FIG. 1 presents a schematic diagram of the use environment of the present invention. A caller uses an earphone 1 to make a phone call via a near-end phone 2 and network 90 (such as a telecommunications or computer network), and the receiver answers the phone via a far-end phone 3. Both the near-end phone 2 and far-end phone 3 are electronic devices able to make a phone call, such as a cell phone, computer (Internet calling), wireless interphone, etc. The far-end phone 3 may be a traditional landline phone. In the present invention, the receiver is not a normal person but a hearing-impaired person or an elderly person.

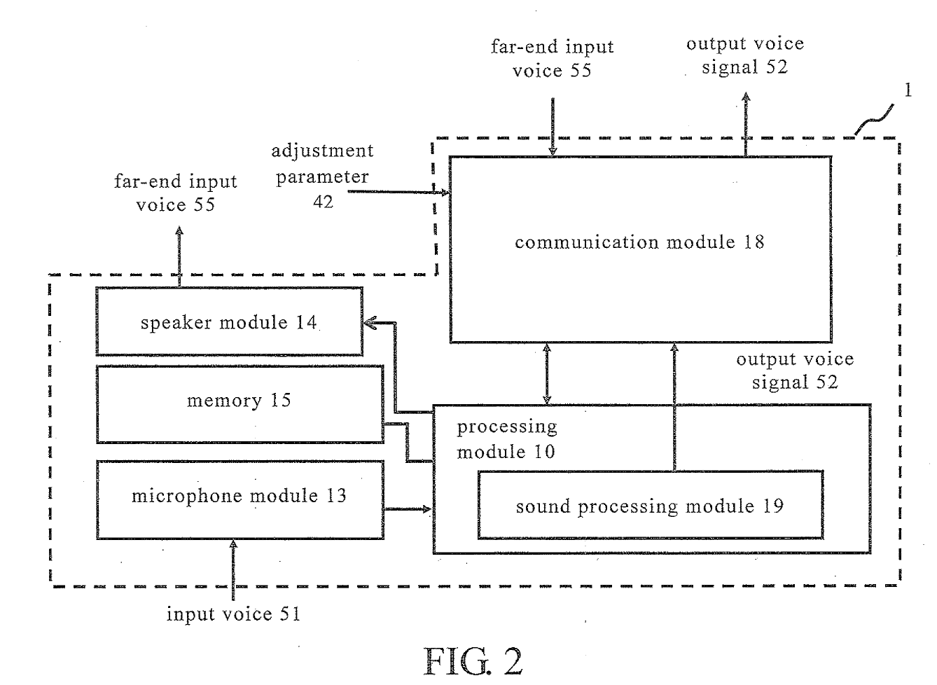

FIG. 2 presents a hardware structure drawing of the earphone of the present invention. The earphone 1 may be electrically connected to a near-end phone 2 (it is wirelessly connected in the embodiment). The earphone 1 comprises: a microphone module 13, a speaker module 14, a memory 15, a communication module 18 and a sound processing module 19, wherein the microphone module 13, the memory 15, the speaker module 14 and the sound processing module 19 are all electrically connected to a communication module 18. The functions of the hardware are described in detail below.

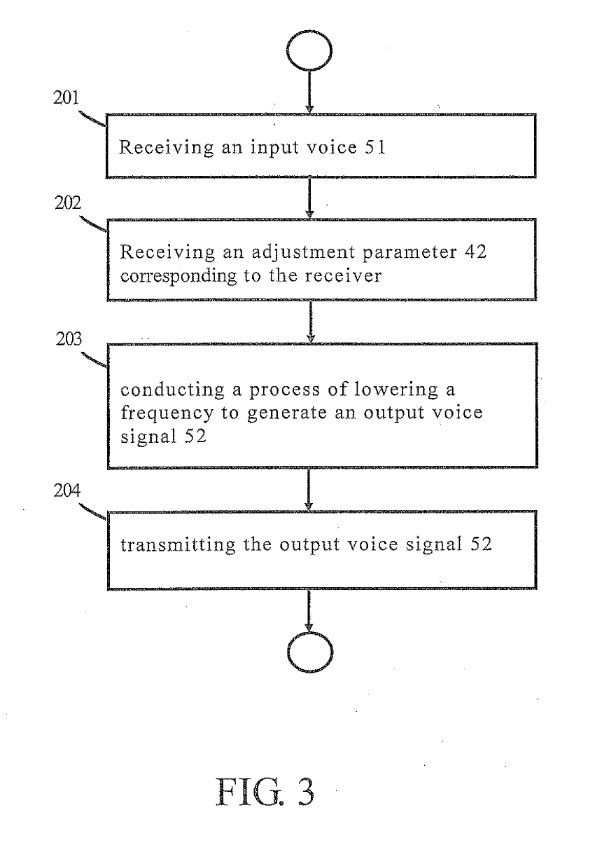

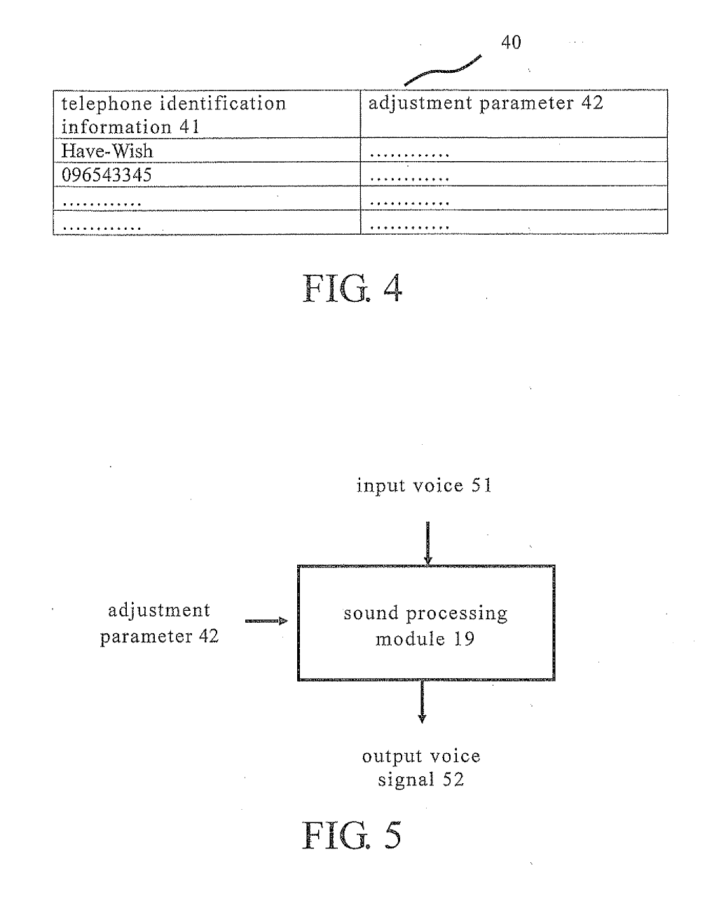

Please refer to FIG. 3, which is a flowchart of the present invention, in conjunction with FIG. 1, FIG. 2, FIG. 4 and FIG. 5 for clearer understanding of the present invention.

Step 201: receiving an input voice 51.

The caller makes a phone call to the receiver via the near-end phone 2. The near-end phone 2 is an electronic device able to make a phone call. The user needs to enter the telephone identification information 41, such as a phone number, identification number or member account (in Internet calling). After calling, the caller puts the earphone 1 (like a Bluetooth earphone) on. The microphone module 13 may receive an input voice 51 (the voice of the caller) and transmit it to the sound processing module 19 in a processing module 10.

Step 202: receiving an adjustment parameter 42 corresponding to the receiver.

According to the telephone identification information 41 (such as a phone number or user name), a sound processing module 19 receives an adjustment parameter 42 corresponding to the receiver. There are two methods to receive the adjustment parameter 42 corresponding to the receiver, and the descriptions are as follows.

The first method is to receive it from the own near-end phone 2 or an adjustment parameter database 40 stored in the memory 15 in the earphone 1. FIG. 4 presents a schematic diagram of the present invention illustrating the adjustment parameter database 40 and comprises two columns of the telephone identification information 41 and the adjustment parameter 42.

The adjustment parameter 42 in the database may be received from the far-end phone 3 transmitting it to the near-end phone 2 directly, or downloaded from an adjustment parameter service 70 via the network 90.

Basically, the adjustment parameter database 40 stores all the adjustment parameters 42 of the hearing-impaired people who register for the service, but if the adjustment parameter database 40 is stored in the memory 15, it is better to store only the information of the receiver whom the user knows. When the adjustment parameter database 40 is changed (for example, the adjustment parameter 42 of the receiver A in the adjustment parameter database 40 is changed), the adjustment parameter 42 of the receiver A in the adjustment parameter database 40 is changed as well.

The adjustment parameter 42 can be determined via some listening tests. For example, the hearing-impaired people may connect to the adjustment parameter service 70 via a computer and generate the adjustment parameter 42 through participating in listening tests. The adjustment parameter 42 records information about amplification parameters, hearing parameters (such as the hearing parameters of the hearing-impaired people) or frequency-variable parameters (such as the parameter of lowering frequency or the parameter of changing frequency). Methods of changing a sound output according to the parameter 42 are well-known to those skilled in the art, so the detailed description is omitted here.

The second method is that there does not need an adjustment parameter service 70 in the near-end phone 2 or in the memory 15 of the earphone 1. The adjustment parameter database 40 is stored in the adjustment parameter service 70. After the processing module 10 receives the telephone identification information 41 of the receiver (the information is transferred immediately when the caller calls the receiver), the adjustment parameter 42 is acquired from searching the adjustment parameter database 40 via an Internet connection. For example, the near-end phone 2 transmits the telephone identification information 41 to the adjustment parameter service 70 so as to search for the corresponding adjustment parameter 42 and access it for use directly.

In the embodiment, the communication module 18 is a Bluetooth communication module. If the first method is used, the adjustment parameter 42 may be acquired from the adjustment parameter database 40 of the near-end phone 2; if the second method is used, the adjustment parameter 42 may be acquired via an Internet connection. Eventually, the adjustment parameter 42 will be transmitted from the near-end phone 2 to the communication module 18 in the earphone 1 via Bluetooth and received by the communication module 18.

Step 203: conducting a frequency lowering process to generate an output voice signal 52.

As shown in FIG. 5, the sound processing module 19 processes the input voice 51 according to the adjustment parameter 42. If the voice frequency is too high for the receiver, the input voice 51 may be processed to lower the frequency and generate an output voice signal 52. The sound processing module 19 is commonly used in a hearing aid for, for example, shifting the frequency of or compressing high-frequency sounds, or conducting a process of amplification on high-frequency sounds.

Step 204: transmitting the output voice signal 52.

As shown in FIG. 5 as well, the communication module 18 transmits the output voice signal 52 to the near-end phone 2 and then to the far-end phone 3 via Bluetooth. The far-end phone 3 transforms the output voice signal 52 to sound wave for being heard by the receiver.

If both the caller and the receiver are hearing-impaired, the near-end phone 2 and the far-end phone 3 may change their voices according to the adjustment parameters 42 of each other.

Of course, the voice of the caller may not be processed if the caller and the receiver are not hearing-impaired people, or if the caller and the receiver are hearing-impaired people who have not registered their adjustment parameters 42. In addition, the quality of the telecommunication signals, the frequency of which in many cases is 0˜4 kHz, makes it difficult for people with normal hearing to understand clearly a conversation on the phone. Therefore, for people with normal hearing, there is no need for Step 202, and a frequency processing method with a default setting (such as a parameter with a default setting stored in the memory 15) can process the voice frequency to 0˜4 kHz. After applying this method of the present invention, people with normal hearing may be able to hear high-frequency aspirated consonants clearly. In addition, it is possible that the search for the user's adjustment parameter 42 in Step 202 may fail. In that case, parameters with default settings are used for processing the voice.

It should be noted that, although a few exemplary embodiments of the present invention have been shown and described, the present invention is not limited to the described exemplary embodiments. Instead, it will be appreciated by those skilled in the art that changes may be made to these exemplary embodiments without departing from the principles and spirit of the invention, the scope of which is defined by the claims and their equivalents.

What is claimed is:

1. A method of outputting a telephone voice is used in an earphone, the earphone electrically connected to a near-end phone, the method comprising:
receiving an input voice via a microphone module;
generating an output voice signal via a sound processing module with conducting a frequency lowering process; and
transmitting the output voice signal to the near-end phone via a communication module;
whereby the near-end phone can transmit the output voice signal to a far-end phone.

2. The method of outputting telephone voice as claimed in claim 1, further comprising: processing the input voice according to an adjustment parameter via the sound processing module.

3. The method of outputting telephone voice as claimed in claim 2, wherein the adjustment parameter is received by the communication module.

4. The method of outputting telephone voice as claimed in claim 3, wherein the adjustment parameter records an amplification parameter, a hearing parameter or a frequency-variable parameter.

5. The method of outputting telephone voice as claimed in claim 4, wherein the adjustment parameter is transmitted from the near-end phone to the communication module.

6. The method of outputting telephone voice as claimed in claim 5, wherein the communication module is a Bluetooth communication module.

7. A earphone is electrically connected to a near-end phone, the earphone comprising:
a microphone module used for receiving an input voice;
a sound processing module electrically connected to the microphone module and used for conducting a frequency lowering process so as to generate an output voice signal;
a communication module electrically connected to the sound processing module and used for transmitting the output voice signal to the near-end phone; and
a speaker module electrically connected to the communication module;
whereby the near-end phone can transmit the output voice signal to a far-end phone.

8. The earphone as claimed in claim 7, wherein the sound processing module processes the input voice according to an adjustment parameter.

9. The earphone as claimed in claim 8, wherein the adjustment parameter is received by the communication module.

10. The earphone as claimed in claim 9, wherein the adjustment parameter records an amplification parameter, a hearing parameter or a frequency-variable parameter.

11. The earphone as claimed in claim 10, wherein the adjustment parameter is transmitted from the near-end phone to the communication module.

12. The earphone as claimed in claim 11, wherein the communication module is a Bluetooth communication module.
